(19) United States
(12) Patent Application Publication
(10) Pub. No.: US 2023/0177456 A1
(43) Pub. Date: Jun. 8, 2023

(54) METHOD AND DEVICE FOR GOODS MANAGEMENT

(71) Applicant: Seuster KG, Ludenscheid (DE)

(72) Inventor: Jörg FISCHER, Dortmund (DE)

(21) Appl. No.: 17/908,815

(22) PCT Filed: Mar. 2, 2021
(86) PCT No.: PCT/EP2021/055179

§ 371 Date: Sep. 1, 2022

(30) Foreign Application Priority Data
Mar. 4, 2020 (DE) 10 2020 105 827.6

(51) Int. Cl. G06Q 10/087; G06K 19/07

(52) U.S. Cl. CPC G06Q 10/087; G06K 19/0723

(57) ABSTRACT

The invention relates to a method for goods management according to which an RFID tag is assigned to the goods and electromagnetic signals are exchanged between the RFID tag and an antenna assembly, wherein, for the purpose of signal exchange, the goods with the RFID tags are arranged in an exchange cell that contains the antenna assembly and that is at least partially shielded.

### CROSS REFERENCE TO RELATED APPLICATION

The present application is a 35 U.S.C. § 371 national phase entry application of, and claims priority to, International Patent Application No. PCT/EP2021/055179, filed Mar. 2, 2021, which claims priority to German Patent Application No. DE 102020105827.6, filed Mar. 4, 2020, the disclosures of which are hereby incorporated by reference in their entirety for all purposes.

### BACKGROUND

The invention relates to a method for goods management in which an RFID tag is assigned to the goods and electromagnetic signals are exchanged between the RFID tag and an antenna assembly.

Such methods are used, for example, in production processes in which the goods are delivered and further processed as part of a production process. In automated production processes, the flow of goods must be monitored and controlled. For this purpose, an RFID tag is assigned to the goods, in which tag the data identifying the goods and/or data identifying the destination of the goods are stored. This data is recorded by suitable antenna assemblies, evaluated with a suitable control and evaluation device, and the corresponding goods are integrated into the flow of goods according to the data received.

Corresponding methods for goods management are also required in logistics centers in which delivered goods are stored and transported from for dispatch to destinations. Goods management in corresponding logistics centers also requires the collection of data identifying the type of goods and the destination for the goods, which data can be stored in RFID tags. These RFID tags can be arranged on the goods themselves or on goods carriers, such as pallets for the goods. In the course of goods management, the antenna assembly usually emits signals which are modulated by the RFID tags by means of field weakening in the contact-free short circuit or anti-phase reflection. The electromagnetic signals modulated in this way can be received by the antenna assembly and evaluated with the aid of a suitable control and evaluation device.

In conventional methods of the type just described, however, malfunctions occur in many cases in which the goods are not properly integrated into the flow of goods.

In view of these problems in the prior art, the invention is based on the object of providing a method for goods management with which a trouble-free flow of goods is made possible, and on the object of providing a corresponding system.

According to the invention, this object is achieved by a refinement of the known methods, in which the goods with the RFID tag are arranged for signal exchange in an at least partially shielded exchange cell containing the antenna assembly.

For the purposes of this description, the term shielded is understood to mean a shielding of electromagnetic radiation, with which the passage of electromagnetic radiation is counteracted.

The invention is based on the finding that the problems observed in conventional goods management methods are primarily due to the fact that the electromagnetic signals emitted by the antenna assembly are modulated by a plurality of tags and are received and evaluated in a correspondingly modulated form by the antenna assembly, which can lead to malfunctions in the assignment of the signals to the individual goods and in the goods management carried out on the basis of this assignment. In the method according to the invention, the signal exchange between the RFID tag and the antenna system takes place in a shielded cell. The modulation of the electromagnetic signal emitted by the antenna assembly, which is detected by the antenna assembly, is therefore carried out by only one RFID tag arranged in the shielded exchange cell, so that the goods assigned to this RFID tag can be reliably integrated into a flow of goods as intended.

RFID tags outside the exchange cell do not even receive any signals emitted by the antenna assembly arranged in the shielded exchange cell. Accordingly, no signals modulated by RFID tags arranged outside of the exchange cell are received by the antenna assembly. Interference from superimposing different signals can thus be counteracted reliably.

In a particularly preferred embodiment of the method according to the invention, the exchange cell is delimited by elements, which are electrically conductive at least in regions, of which at least one closing element can be moved between an open position allowing the goods to pass into the exchange cell and a closed position counteracting the escape of electromagnetic radiation from the exchange cell, wherein the closing element is moved into the open position for arranging the goods in the exchange cell and into the closed position for the purpose of signal exchange between the RFID tag and the antenna assembly arranged in the exchange cell.

In the case of the method according to the invention, the goods can be arranged in the exchange cell, on the one hand, by the goods themselves being conveyed into the exchange cell, optionally on a goods carrier. In other embodiments of the invention, the exchange cell is moved into the area of stationary stored goods. In both embodiments of the method according to the invention, it is essential that the exchange cell allows the goods to enter the exchange cell by moving the closing element into the open position and it can then be shielded on all sides by moving the closing element into the closed position.

In a particularly preferred embodiment of the invention, it is provided that the exchange cell has two closing elements, preferably forming opposite sides of the exchange cell, one of which is moved into the open position to arrange the goods in the exchange cell and the other is moved into the open position to remove the goods from the exchange cell. In this embodiment of the invention, the method according to the invention for goods management enables continuous operation and thus an overlap-free signal exchange without delaying the flow of goods. The exchange cell can be moved between two or more exchange locations when carrying out methods according to the invention. Additionally or alternatively, the goods with the assigned RFID tag can pass through the exchange cell.

As can be seen from the above description of methods according to the invention, an exchange cell suitable for carrying out a method according to the invention for goods management has an antenna assembly arranged in the exchange cell, wherein the exchange cell itself is delimited by at least one element made of at least partially electrically conductive material, in particular metallic material, with which it is possible to shield the electromagnetic signal transmitted during the signal exchange. At least one delimiting element can have a closing element that can be moved between an open position, in which it enables the arrangement of goods in the exchange cell, and a closed position, in which it counteracts the escape of electromagnetic radiation from the exchange cell.

In one embodiment of the invention that enables an exchange cell according to the invention to be integrated into a flow of goods, at least two preferably opposite sides of the exchange cell have closing elements, each of which can be moved between an open position and a closed position, so that, by moving one closing element into the open position, the arrangement of the goods in the exchange cell is possible and, by moving the other closing element into the open position, the removal of the goods from the exchange cell is possible. During the signal exchange between the RFID tags assigned to the goods and the antenna assembly, preferably both closing elements are in the closed position.

A particularly rapid movement of the closing elements between the closed position and the open position is made possible if at least one closing element forms a multi-layer roll in the open position, wherein a further acceleration of the movement of the closing element between the open position and the closed position is possible if at least one closing element has a web-shaped curtain which is coated with a metallic material on at least one side and can be wound on a winding shaft in the open position, from which winding shaft it is unwound during a closing movement. Aluminum, for example, can be used as the metallic material for the shielding coating of the closing element.

The web-shaped curtain can be a component made of a flexible material, such as a plastic film, which has a metallic coating, such as an aluminum coating. A curtain in the form of such an aluminum-coated plastic film allows a large number of windings on a shaft without wear. In addition, a corresponding material is very light and can therefore be moved between the closed position and the open position at high speed without excessive effort. A motor with small dimensions can be used to wind up and unwind the curtain, while at the same time realizing a large number of load cycles, which is particularly advantageous in an automated solution with short cycle times.

In a particularly preferred embodiment of the invention, the curtain is formed at least partially from a sheet material having mineral fibers, such as a fiberglass or glass fabric, with a metallic coating, such as an aluminum coating. In addition to the shielding effect, corresponding products also have an improved fire protection effect. They are barely flammable.

Within the scope of the invention, at least one delimiting element can have a rigid wall element, wherein the rigid wall element can have a metal sheet, in particular in the form of a sectional door panel.

The exchange cell provided according to the invention can also be delimited overall by aluminum-coated foils or fabrics. Consideration is also given to covering the rigid boundary walls of the exchange cell with a corresponding flexible material having an aluminum coating. Thus, a very light and cost-effective design form can be realized, which can be individually and easily adapted in size and shape. Such an exchange cell can be either stationary or mobile.

Particularly with regard to an optionally desired mobile design of the exchange cell, it has proven to be expedient if the wall elements are inserted into a rigid frame, which is preferably formed from metal bars or profiles. Transport elements such as rollers and/or wheels, on which the exchange cell can be moved between exchange locations, are expediently attached to the frame in this embodiment of the invention.

A goods management system according to the invention comprises an exchange cell according to the invention with an antenna assembly arranged therein and a goods carrier equipped with an RFID tag. The goods carrier can be designed as a pallet.

### BRIEF DESCRIPTION OF THE DRAWINGS

The invention is explained below with reference to the drawing, to which express reference is made with regard to all the details that are essential to the invention and not detailed in the description. In the drawing:

FIG. 1 shows an exchange cell according to the invention with the closing element moved into the closed position; and

FIG. 2 shows an exchange cell according to the invention with the closing element moved into the open position.

### DETAILED DESCRIPTION

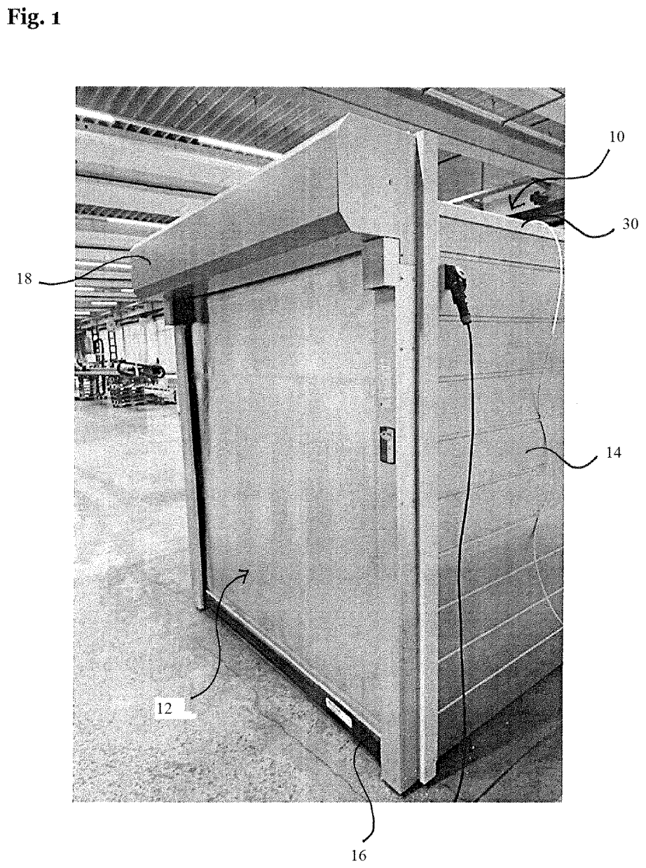

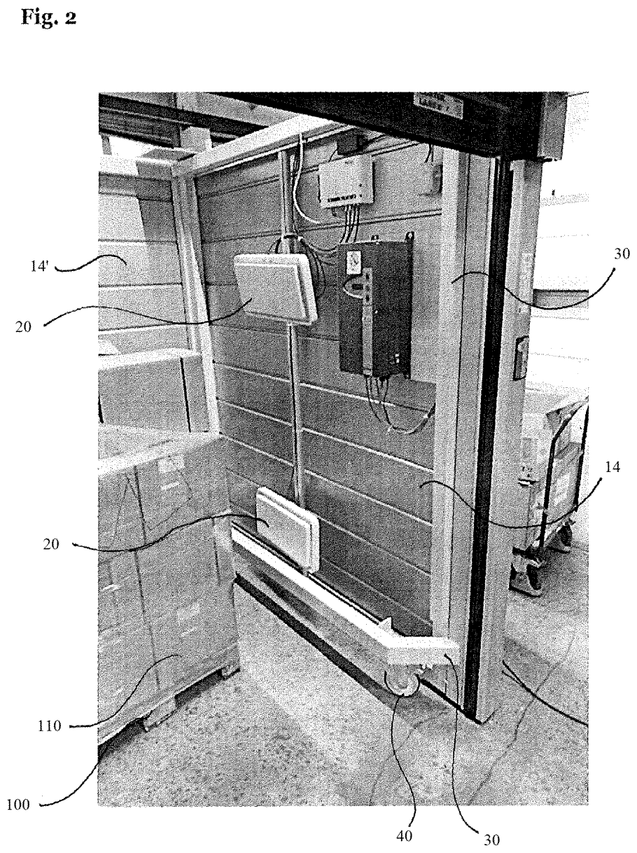

The exchange cell 10 shown in the drawing is essentially cuboid and is delimited on three sides by delimiting elements in the form of rigid walls 14. The rigid walls 14 have metal sheets and are made of sectional door panels in the embodiment of the invention shown in the drawing. In the embodiment of the invention shown in the drawing, the remaining side of the exchange cell is implemented by a closing element in the form of a web-shaped curtain 12 which can be moved between the closed position shown in FIG. 1 and the open position according to FIG. 2. In the closed position (cf. FIG. 1), a stabilizing profile 16 arranged at the lower edge of the web-shaped closing element 12 rests on the cell floor. In the open position (cf. FIG. 2), the closing element 12 designed as a web-shaped curtain is wound up into a multi-layer roll and arranged in a housing 18 above the opening of the exchange cell 10, which opening is closed by the closing element 12 in the closed position.

As can already be seen in FIG. 1, the delimiting elements 14, 16 are accommodated in a frame formed by metal bars 30. The frame forms the edges of the cuboid defining the exchange cell. An antenna assembly 20 is provided in the exchange cell, which antenna assembly has two antennas in the embodiment of the invention shown in FIG. 2. The antenna assembly 20 is designed to emit electromagnetic signals and to receive signals modulated by an RFID tag. In the embodiment of the invention shown in FIG. 2, the goods 110 are arranged on a pallet 100 serving as a goods carrier. In this embodiment of the invention, the RFID tag is arranged on the goods carrier 100. After the signal exchange between the RFID tag and the antenna assembly 20, the goods 110 arranged on the goods carrier 100 can be removed from the exchange cell and integrated into the flow of goods.

In the embodiment of the invention shown in FIG. 2, the exchange cell 10 is equipped with transport rollers 40, which are attached to the lower metal bars 30 of the frame accommodating the delimiting elements 12 and 14. This makes it possible to move the exchange cell 10 as a whole on the rollers 40.

The curtain 12 that can be seen in FIG. 1 is coated with aluminum.

In the embodiments of the invention shown in the drawing, only one delimiting element of the exchange cell is designed as a closing element 12, which can be moved between an open position (cf. FIG. 2) and a closed position (cf. FIG. 1). In a preferred embodiment of the invention, two opposite walls of the exchange cell 10 are formed by corresponding closing elements. This means that the delimiting element identified by reference number 14′ in FIG. 2 is replaced by a closing element, such as a web-shaped curtain.

The invention is not limited to the exemplary embodiment illustrated by means of the drawing. Rather, it is also conceivable to design the closing element in the manner of a sectional door with rigid closing elements. The antenna assembly can have more than two or only one antenna. The delimiting elements designed as rigid walls can be formed in one piece. The provision of a frame formed by metal bars 30 can be dispensed with.

1. A method for goods management, in which an RFID tag is assigned to the goods and electromagnetic signals are exchanged between the RFID tag and an antenna assembly, characterized in that the goods with the RFID tag for signal exchange are arranged in an at least partially shielded exchange cell, which contains the antenna assembly.

2. The method according to claim 1, characterized in that the exchange cell is delimited by elements, which are electrically conductive at least in regions, of which at least one closing element can is to be moved between an open position allowing the goods to pass into the exchange cell and a closed position counteracting the escape of electromagnetic radiation from the exchange cell, wherein the closing element is moved into the open position for arranging the goods in the exchange cell and into the closed position for data exchange between the RFID tag and the antenna assembly.

3. The method according to claim 1, characterized in that the exchange cell has two closing elements, forming opposite sides of the exchange cell, one of which is moved into the open position to arrange the goods in the exchange cell and the other is moved into the open position to remove the goods from the exchange cell.

4. The method according to claim 1, characterized in that the exchange cell is moved between exchange locations.

5. The method according to claim 1, characterized in that the goods with the assigned RFID tag pass through the exchange cell.

6. An exchange cell for goods management for carrying out a method according to claim 1 with an antenna assembly arranged in the exchange cell, in which antenna assembly the exchange cell is delimited by at least one element made of at least partially electrically conductive material, including metallic material.

7. The exchange cell according to claim 6, characterized in that at least one delimiting element has a closing element that is to be moved between an open position, in which it enables the arrangement of goods in the exchange cell, and a closed position, in which it counteracts the escape of electromagnetic radiation from the exchange cell.

8. The exchange cell according to claim 7, characterized in that at least two sides of the exchange cell, opposite one another, have closing elements, each of which is to be moved between an open position and a closed position.

9. The exchange cell according to claim 7, characterized in that at least one closing element forms a multi-layer roll in the open position.

10. The exchange cell according to claim 9, characterized in that at least one closing element has a web-shaped curtain, which is coated on at least one side with a metallic material, including aluminum.

11. The exchange cell according to claim 10, characterized in that the web-shaped curtain has mineral fibers, including glass fibers, and includes, at least in sections, a sheet material made of mineral fibers, including glass fibers, such as glass fabric, coated with a metallic material such as aluminum.

12. The exchange cell according to claim 6, characterized in that at least one delimiting element has a rigid wall element.

13. The exchange cell according to claim 12, characterized in that the rigid wall element has a metal sheet, and comprises a sectional door panel, and/or is covered with a flexible material equipped with a metallic coating, such as a coated plastic film, and/or with a coated sheet material made of mineral fibers.

14. The exchange cell according to claim 6, characterized in that the wall elements are inserted into a rigid frame, preferably formed from metal bars or profiles.

15. The exchange cell according to claim 6, characterized by transport elements, such as rollers, preferably attached to the frame, and/or wheels on which the exchange cell is movable between exchange locations.

16. A goods management system with the exchange cell of claim 6 and a goods carrier equipped with an RFID tag.
